(19) United States
(12) Patent Application Publication
(10) Pub. No.: US 2020/0189672 A1
(43) Pub. Date: Jun. 18, 2020

(54) SMALL TRACKED VEHICLE

(71) Applicant: OBSCHESTVO S OGRANICHENNOJ OTVETSTVENNOSTYU "SNOUBAJK", Moscow (RU)

(72) Inventor: Maksim Vladimirovich GNEDOV, Samara (RU)

(21) Appl. No.: 16/468,440

(22) PCT Filed: Oct. 12, 2017
(86) PCT No.: PCT/RU2017/000760

§ 371 Date: Jun. 11, 2019

(30) Foreign Application Priority Data
Dec. 12, 2016 (RU) 2016148614

(51) Int. Cl. B62D 55/14; B62D 55/104

(52) U.S. Cl. CPC B62D 55/14; B62D 55/104

(57) ABSTRACT

A compact tracked vehicle relates to the field of transport technologies, in particular to compact tracked electric vehicles intended for use on rough surfaces (snow, sand, gravel, dirt), the claimed device may be used in combination with different types of pull-type and attachable equipment for purposes of entertainment, as a part of robotic platforms, and for human and small cargo transportation. A technical effect achieved by the claimed technical solution is reducing dimension and weight characteristics of a tracked vehicle and simplification of its structure by means of a compact tracked vehicle characterised in that it comprises a frame, an electric motor, a track, support rollers, and a traction wheel, wherein an electric motor shaft is fixed with respect to the frame, an electric motor housing is rotatably positioned with respect to the shaft, and the traction wheel is co-axial to the electric motor shaft and arranged for simultaneous rotation with the electric motor housing; the electric motor is double sided; the traction wheel is annular, provided with outer grips, and positioned directly on the electronic motor housing; the vehicle further comprises rechargable baterries; and a platform positioned on the frame and equipped with fastening means for an external equipment.

A device in accordance with present disclosure relates to the field of transport technologies, in particular to compact tracked electric vehicles intended for use on rough surfaces (snow, sand, gravel, dirt), the claimed device may be used in combination with different types of pull-type and attachable equipment for purposes of entertainment, as a part of robotic platforms, and for transportation of humans and small cargos.

Patent for a utility model RU 162476 of 23 Dec. 2015 published on 10 Jun. 2016, IPC B62M27/02, B62D55/08, B60L11/18 discloses “A Compact Vehicle”, comprising a housing; and an engine fixed on a frame, a steereing wheel having control elements, a coupling unit, a tracked propulsor including a track, a spring loaded sopport rollers, a traction wheel coupled wth the engine through a chain drive, the engine of the vehicle is implemented as a brushless DC electric motor having rechargeable batteries, a contactor, and a controller, attached to the frame above the track and enclosed by the housing with a top part of the track, wherein the contactor is electrically coupled to the rechargeable batteries, the controller comprising a software is electrically coupled with the electric motor, the rechargeable batteries, the contactor, and the control elements mounted on the steereng wheel; the control elements of the vehicle are implemented as power on/off, propulsion, brakeage, and backward motion control elements; the power on/off element is coupled to the power safety shutdown means implemented as a chord having a quick-release fastener.

The closest analogue of the claimed device is “A Personal Tracked Vehicle” disclosed in U.S. Pat. No. 6,435,290 B1 of 20 Aug. 2002, IPC B62D55/00, the device comprising an electric motor and a tracked propulsor mounted on a frame, wherein the tracked propulsor comprises one track, support rollers and a traction wheels kinetically coupled with the electric motor, mounted above on the frame, through a flexible gear, for example a chain gear or a belt gear.

All known structures of compact tracked vehicles utilize additional mechanisms for transmitting rotation from the shaft of power unit to the shaft of the traction wheel of the tracked propulsor, for example belt or chain gears, crown wheels, etc. In majority of designs said transmitting mechanisms act also as reduction units. Using additional mechanisms for transmitting rotation from engine allows conversion of torque, but also increase dimensions and weight of a vehicle, makes its structure more complicated, and results in power losses due to additional friction forces.

An object of the present invention is to reduce dimension and weight characteristics of a tracked vehicle and simplify its structure.

The object is addressed by a compact tracked vehicle characterised in that it comprises a frame, an electric motor, a track, support rollers, and a traction wheel, wherein an electric motor shaft is fixed with respect to the frame, an electric motor housing is rotatably positioned with respect to the shaft, and the traction wheel is co-axial to the electric motor shaft and arranged for simultaneous rotation with the electric motor housing; the electric motor is double sided; the traction wheel is annular, provided with outer grips, and positioned directly on the electronic motor housing; the vehicle further comprises rechargable baterries; a platform positioned on the frame and equipped with fastening means for an external equipment.

Substance of the invention is illustrated by the drawings, where

FIG. 1 is a general view of a compact tracked vehicle;

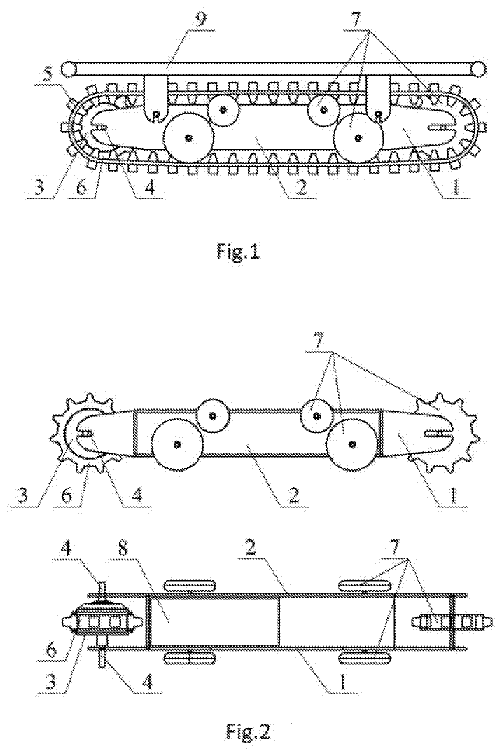

FIG. 2 is a compact tracked vehicle without a track;

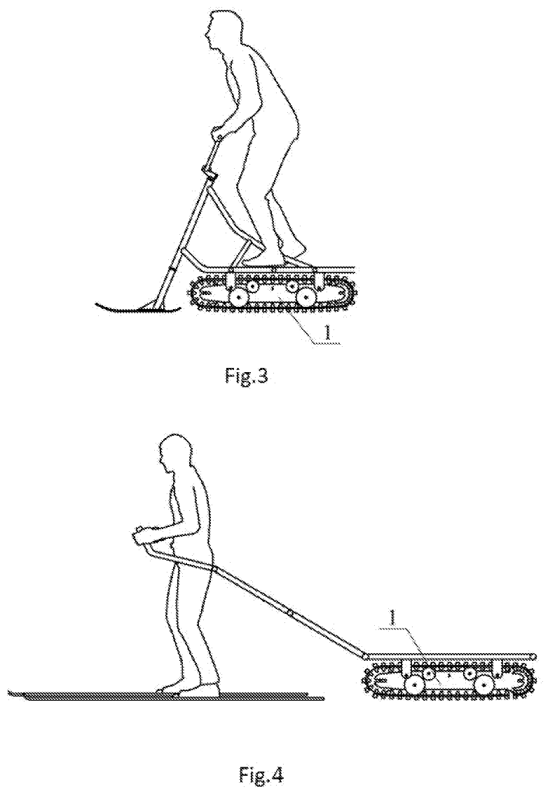

FIG. 3 is a compact tracked vehicle used as a part of sport equipment;

FIG. 4 is a compact tracked vehicle used to tow a skier;

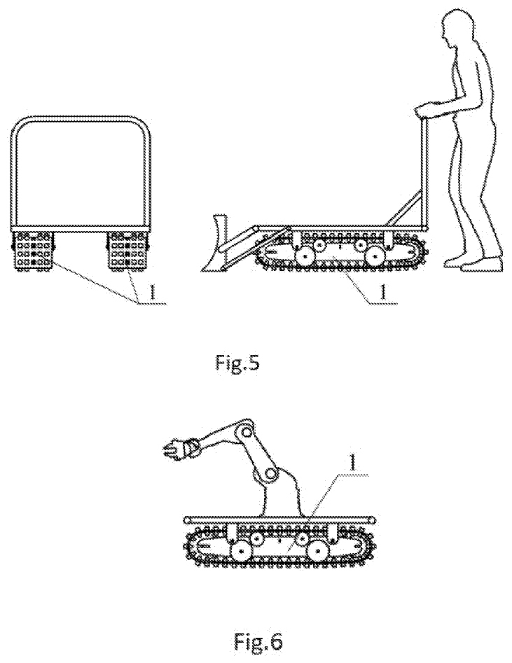

FIG. 5 is a compact tracked vehicle used as a part of a cargo platform;

FIG. 6 is a compact tracked vehicle used as a part of a robotic platform.

FIG. 1, FIG. 2, FIG. 3, FIG. 4, FIG. 5, FIG. 6 show a compact tracked vehicle 1, a frame 2, an electric motor 3, an electric motor shaft 4, a track 5, a traction wheel 6, support wheels 7, rechargeable baterries 8, and a platform 9.

A compact tracked vehicle is implemented in the following way.

The compact tracked vehicle 1 comprises a frame 2 optionally implemented as a space truss. An electric motor 3 is mounted on the frame 2, wherein an electric motor shaft 4 is fixed with respect to the frame 2. A housing of the electric motor 3 is rotateably positioned with respect to the statical shaft 4. A traction wheel 6 is co-axially positioned with respect to the shaft 4 of the electric motor 3 and is rotateble simultaneously with the housing of the electric motor 3. Optionally, the traction wheel 6 is annular and positioned directly on the housing of the electronic motor 3 surrounding it. The traction wheel 6 is provided with outer grips. The traction wheel 6 and the housing of the electric motor 3 may be implemented as a single integral piece. Optionally, the electric motor 3 is double sided. Support wheels 7 are mounted on the frame 2. Optionaly, the support wheels 7 are spring loaded. The compact tracked vehicle 1 comprises a track 5 mounted on the traction wheel 6 and the support wheels 7. The vehicle 1 further comprises rechargable baterries 8. Optionally, th reghargeable batteries 8 are positioned in the frame 2. The vehicle 1 comprises a platform 9 provided on the frame 2 and equipped with a fastening means for an external equipment. The traction wheel 6 and the housing of the electric motor 3 rotating simultaeously around the fixed single shaft 4 form an engine-wheel system.

The compact tracked vehicle operates in the following way.

A control system implemented, for example, as a steering wheel and a steering wheel ski, is installed on the compact tracked vehicle. A voltage is supplied to the electric motor 3, for example, from the rechargeable batteries 8. The rechargeable batterias 8 may either form a part of the device or may be used as an external, for example, detacheable equipment. The electric motor 3 rotates around the shaft 4 fixed on the frame 2. The traction wheel 6 rotates simultaneously with the housing of the electric motor 3, the traction wheel drives the track 5. Absence of additional mechanisms for transmitting rotation from the shaft 4 of the electric motor 3 to the traction wheel 6 provides significant reduction of weight and dimentions of the tracked vehicle 1, thus allowing its transportation to the point of use, for example, on a light motorcar. Further, absence of mechnisms for transmitting rotation provides simplification of the structure of the device 1 and significant reducing losses of the power being transmitted to the track 5 due to minimizing a number of units and, therefore, reducing the frictional forces. Reducing a number of mechanically engaging elements significantly improves reliability and extends overall life span of the device.

A technical effect achieved by the claimed technical solution is reducing dimension and weight characteristics of a tracked vehicle and simplification of its structure by means of a compact tracked vehicle characterised in that it comprises a frame, an electric motor, a track, support rollers, and a traction wheel, wherein an electric motor shaft is fixed with respect to the frame, an electric motor housing is rotatably positioned with respect to the shaft, and the traction wheel is co-axial to the electric motor shaft and arranged for simultaneous rotation with the electric motor housing; the electric motor is double sided; the traction wheel is annular, provided with outer grips, and positioned directly on the electronic motor housing; the vehicle further comprises rechargable baterries; and a platform positioned on the frame and equipped with fastening means for an external equipment.

1. A compact tracked vehicle, comprising a frame, an electric motor, a track, support wheels, and a traction wheel, characterised in that an electric motor shaft is fixed with respect to the frame, the electric motor housing is rotatably positioned with respect to the shaft, and the traction wheel is co-axial to the electric motor shaft and arranged for simultaneous rotation with the electric motor housing.

2. The compact tracked vehicle of claim 1, wherein the electric motor is double sided.

3. The compact tracked vehicle of claim 1, wherein the traction wheel is annular, provided with outer grips, and positioned directly on the electronic motor housing.

4. The compact tracked vehicle of claim 1, wherein it further comprises rechargable baterries.

5. The compact tracked vehicle of claim 1, wherein it comprises a platform positioned on the frame and equipped with fastening means for an external equipment.
